(19) United States
(12) Patent Application Publication
(10) Pub. No.: US 2012/0016091 A1
(43) Pub. Date: Jan. 19, 2012

(54) Halogenated Butyl Rubber Having Superior Reactivity

(76) Inventors: J. Scott PARENT, Kingston (CA); Ralph A. WHITNEY, Kingston (CA)

(21) Appl. No.: 13/183,576

(22) Filed: Jul. 15, 2011

Related U.S. Application Data
(60) Provisional application No. 61/364,454, filed on Jul. 15, 2010.

(51) Int. Cl. C08F 8/48

(52) U.S. Cl. 525/370

(57) ABSTRACT

A process is described for isomerizing halogenated butyl rubber from a microstructure that is predominantly exo-methylene (secondary allylic halide) to one that is predominantly endo-halomethyl (primary allylic halide). Isomerized halobutyl rubber is a halobutyl rubber that is more reactive toward a wide range of nucleophiles, thereby supporting more efficient processes for producing a variety of butyl rubber derivatives. The process includes mixing halogenated butyl rubber and a catalytic amount of metal carboxylate and optionally heating to form isomerized halogenated butyl rubber, and may be conducted in the absence or presence of solvent.

### RELATED APPLICATIONS

This application claims the benefit of the filing date of U.S. Provisional Patent Application No. 61/364,454, filed on Jul. 15, 2010, the contents of which are incorporated herein by reference in their entirety.

### FIELD OF THE INVENTION

The present invention relates to increasing the reactivity of halogenated butyl rubber by changing its isomer composition through a catalytic rearrangement. Specifically, halogenated butyl rubber is catalytically converted from an initial microstructure having a low mole fraction of primary allylic halide to a final microstructure having a significantly higher mole fraction of primary allylic halide.

### BACKGROUND OF THE INVENTION

Poly(isobutylene-co-isoprene) (“IIR”) is a synthetic elastomer commonly known as butyl rubber that has been prepared since the 1940's through random cationic copolymerization of isobutylene with small amounts of isoprene (1-2 mole %). IIR possesses superior gas impermeability, excellent thermal stability, good resistance to ozone oxidation, exceptional dampening characteristics, and extended fatigue resistance. The term “butyl rubber” is used to describe a copolymer made from polymerization of a mixture having about 85 to 99.5% by weight of isobutylene with about 15 to 0.5% by weight of a conjugated diene such as isoprene. Butyl rubber as presently produced has a limited amount of unsaturation through incorporation of isoprene randomly in its polymeric backbone (see FIG. 1). In many of its applications, butyl rubber is cross-linked to generate thermoset articles with greatly improved modulus, creep resistance and tensile properties. Alternate terms for crosslinking include vulcanizing and curing. Vulcanizing systems include sulfur, quinoids, resins, sulfur donors and low-sulfur, high-performance vulcanization accelerators.

To enhance its cure reactivity, IIR can be halogenated to introduce allylic halide sites. Halogenation of IIR is typically carried out by reacting chlorine or bromine and butyl rubber dissolved in hydrophobic solvent, in the presence of water to form chlorobutyl rubber (CIIR) or bromobutyl rubber (BIIR). Commercial grades of both of these halobutyl (XIIR) rubbers are known in the rubber industry. CIIR typically contains about 1 to about 3 wt % isoprene, about 0.5 wt % to about 2.5 wt % chlorine, and about 97 wt % to about 99 wt % isobutylene, relative to hydrocarbon content. BIIR typically contains from about 1 to about 3 wt % isoprene, about 97 wt % to 99 wt % isobutylene, and about 1 wt % to about 4 wt % bromine, relative to hydrocarbon content. When treated with standard vulcanization formulations, materials such as CIIR and BIIR cure significantly faster than IIR. However, there exists a need for methods to enhance the reactivity of halobutyl rubber. Such enhancement would allow for reaction with a greater variety of nucleophiles. Due to its low reactivity, chlorobutyl rubber is not commonly used. A method for enhancing its reactivity may lead to an increase in its use, and to the discovery of many new materials. Also, by overcoming the low reactivity deficiency of chlorobutyl rubber, such methods could provide cost savings since chlorobutyl rubber is less expensive than bromobutyl rubber.

### SUMMARY OF THE INVENTION

An aspect of the invention provides a process for isomerizing halogenated butyl rubber comprising mixing halogenated butyl rubber and a catalytic amount of metal carboxylate; and forming isomerized halogenated butyl rubber.

An embodiment of this aspect further comprises heating the halogenated butyl rubber and metal carboxylate mixture.

In certain embodiments of the invention, the halogenated butyl rubber is brominated butyl rubber or chlorinated butyl rubber.

In some embodiments, the metal carboxylate is magnesium (stearate)₂, zinc(stearate)₂, iron(napthenate)₂, dibutyltin dilaurate, or a combination thereof.

In some embodiments, the mixing is conducted in the absence of solvent. In certain of such solvent-free embodiments, the mixing is conducted at a temperature from about 50° C. to about 160° C., from about 60° C. to about 140° C., or from about 70° C. to about 120° C.

In certain embodiments of the invention, the mixing is conducted in the presence of solvent. In certain such embodiments of the invention wherein mixing is conducted in the presence of solvent, the solvent is toluene, hexane, tetrahydrofuran, xylene, or a combination thereof. In such embodiments, halobutyl rubber is dissolved to a concentration from about 0.5 wt % to about 25 wt %, or about 5 wt % to about 15 wt %. In some solvated embodiments, the mixing is conducted at a temperature from about 20° C. to about 160° C., about 40° C. to about 140° C., or from about 60° C. to about 120° C. Certain embodiments of the invention wherein the mixing is conducted above the solvent's boiling point, further comprise applying pressure to maintain a liquid-phase.

In certain embodiments of the above aspect of the invention, the metal carboxylate is (R¹COO)M(OOCR²), where M is Be, Mg, Ca, Sr, Ba, or Ra, and R¹ and R² are independently C₁-C₂₀ aliphatic, aryl, or a combination thereof, and optionally may be joined together as a bi-dentate ligand. In some embodiments, the metal carboxylate is magnesium(stearate)₂

In certain embodiments of the above aspect of the invention, the metal carboxylate is (R¹COO)M(OOCR²), where M is an element from one of Groups 3 through 13 or Ge, Sn or Pb of Group 14 of the Periodic Table of the Elements, R¹ and R² are independently C₁-C₂₀ aliphatic, aryl, or a combination thereof, and optionally may be joined together as a bi-dentate ligand. In some embodiments, the metal is zinc or iron. In certain embodiments, the metal carboxylate is zinc(stearate)₂ or iron(napthenate)₂.

In certain embodiments of the above aspect of the invention, the metal carboxylate is (R¹COO)(R²COO)SnR³R⁴, where R¹, R², R³, and R⁴ are independently C₁-C₂₀ alphatic, aryl, or a combination thereof, and optionally two or more of R¹, R², R³, and R⁴ can be joined together as a multi-dentate ligand. In certain embodiments, the metal carboxylate is dibutyltin dilaurate.

### BRIEF DESCRIPTION OF THE DRAWINGS

For a better understanding of the invention and to show more clearly how it may be carried into effect, reference will now be made by way of example to the accompanying drawings, which illustrate aspects and features according to embodiments of the present invention, and in which:

FIG. 1 shows predominant microstructures of butyl rubber.

FIG. 2 shows predominant microstructures of halogenated butyl rubber.

FIG. 3 shows predominant microstructures of conjugated-diene butyl rubber.

FIG. 4 graphically shows solution dynamics for dehydrohalogenation of BIIR to conjugated-diene butyl rubber in xylenes solution at reflux (135° C.) in the presence of Proton-sponge®. This plot shows concentration of functionality relative to weight of polymer (mmol functionality/g of XIIR) versus time (h) for several functionalities, specifically: secondary allylic bromide exo-methylene bromobutyl rubber (∘), primary allylic bromide (E/Z)-endo-bromomethyl butyl rubber (Δ), and exo-conjugated diene butyl rubber ().

FIG. 5 graphically shows a comparison of solution dynamics for rearrangement of BIIR in toluene at 85° C. both alone (upper plot a.) and in the presence of 1 molar equivalent of zinc stearate (lower plot b.) from exo-methylene microstructure (∘, secondary allylic bromide) to (Z)-endo-bromomethyl butyl rubber (⋄, primary allylic bromide) and (E)-endo-bromomethyl butyl rubber (□, primary allylic bromide).

FIG. 6 graphically shows a comparison of solid-state dynamics for rearrangement of BIIR at 85° C. in a batch mixer both alone (upper plot a.) and in the presence of 0.1 molar equivalent of zinc stearate (lower plot b.) from exo-methylene microstructure (∘, secondary allylic bromide) to (Z)-endo-bromomethyl butyl rubber (⋄, primary allylic bromide) and (E)-endo-bromomethyl butyl rubber (□, primary allylic bromide).

FIG. 7 graphically shows solid-state dynamics for rearrangement of BIIR at 85° C. in a batch mixer in the presence of 0.1 molar equivalent of iron naphthenate from exo-methylene microstructure (, secondary allylic bromide) to (Z)-endo-bromomethyl butyl rubber (⋄, primary allylic bromide) and (E)-endo-bromomethyl butyl rubber (□, primary allylic bromide).

FIG. 8 graphically shows solid-state dynamics for rearrangement of CIIR at 120° C. in a batch mixer in the presence of 0.1 molar equivalent of zinc stearate from exo-methylene chlorobutyl rubber (, secondary allylic chloride) to endo-chloromethyl butyl rubber (□, primary allylic chloride) microstructure, exo conjugated-diene butyl rubber (♦), and endo conjugated-diene butyl rubber (⋄).

### DETAILED DESCRIPTION OF THE INVENTION

As described above, there exists a need for enhancing the reactivity of halogenated butyl rubbers. Increased reactivity can be effected by isomerizing halobutyl rubber to increase the amount of primary allylic halide sites and decreasing the number of secondary allylic halide sites. Isomerization methods are presented herein that are moisture-tolerant, and that allow for solvent based and solvent-free isomerization providing product that is substantially gel-free and has substantially no degradation products.

It has surprisingly been found that rearrangement of conventional halogenated butyl rubbers can be effected in the presence of a catalytic amount of metal carboxylate catalyst. In such rearrangements, a substantial fraction of the XIIR's initial microstructure is isomerized from secondary allylic halide to primary allylic halide. This increase in the relative amount of primary allylic halide leads to a XIIR with improved reactivity. Furthermore the isomerization reaction can be carried out in a solvent with no precautions to exclude moisture, and it can be carried out under solvent and solvent-free conditions without producing gel.

### Definitions

As used herein, the term “aliphatic” encompasses saturated or unsaturated hydrocarbon moieties that are straight chain, branched or cyclic and, further, the aliphatic moiety may be substituted or unsubstituted.

As used herein, “aryl” means a moiety including a substituted or unsubstituted aromatic ring, including heteroaryl moieties and moieties with more than one conjugated aromatic ring; optionally it may also include one or more non-aromatic ring. Examples of aryl moieties include, phenyl, biphenyl, naphthyl, anthryl, phenanthryl, pyrenyl, pyridyl, bipyridyl, xylyl, indolyl, thienyl, and quinolinyl.

As used herein, the term “IIR” means poly(isobutylene-co-isoprene), a synthetic elastomer commonly known as butyl rubber that typically has less than 4 mole % isoprene. As used herein, the term “XIIR” means halobutyl rubber. As used herein, the term “BIIR” means brominated butyl rubber. As used herein, the term “CIIR” means chlorinated butyl rubber. As used herein, the term “BIMS” means brominated poly(isobutylene-co-para-methylstyrene).

As used herein, the term “conjugated” refers to covalently bonded atoms that influence each other to produce a region of electron delocalization where electrons do not belong to a single bond or atom, but rather to a group. Conjugation is possible when each contiguous atom in a chain possesses a p-orbital forming a pi bond. A first example of conjugation is a hydrocarbon chain with alternating single and multiple (e.g., double) bonds between the carbon atoms (e.g., C═C—C═C). A second example is a hydrocarbon chain that includes heteroatoms with alternating single and multiple bonds (e.g., C═C—C═O).

As used herein, the terms “curing”, “vulcanizing”, and “crosslinking” are used interchangeably and refer to formation of covalent bonds that link one polymer chain to another, thereby altering the properties of the material.

As used herein, the term “dehydrohalogenation” refers to a β-elimination reaction of an alkyl halide to form an alkene, wherein a hydrogen halide is liberated.

As used herein, the term “pendant group” means a moiety that is attached to a polymer backbone.

As used herein, the terms “polymer backbone” and “PB” mean the main chain of a polymer to which pendant group is attached.

As used herein, the term “secondary allylic halide” refers to a microstructure of halobutyl rubber of the following type:

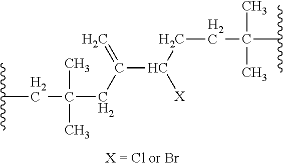

As used herein, the term “primary allylic halide” refers to a microstructure of halobutyl rubber of the following type:

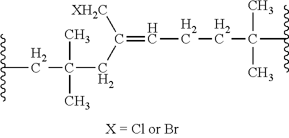

As used herein, the term “isomerized halobutyl rubber” refers to XIIR whose primary allylic halide content exceeds its secondary allylic halide content.

### Description

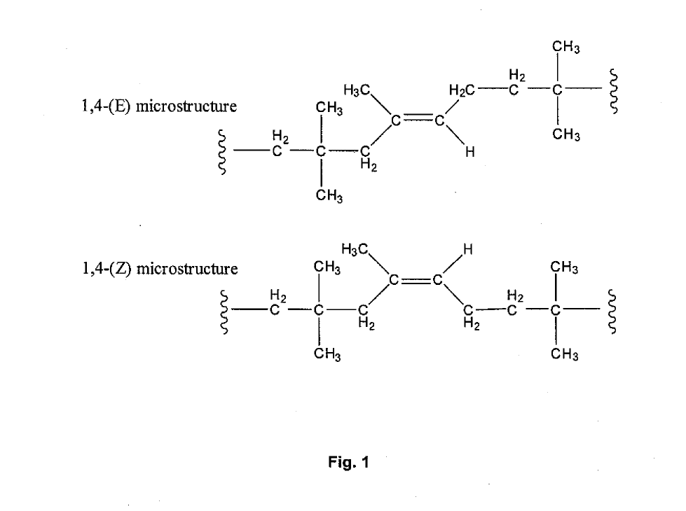

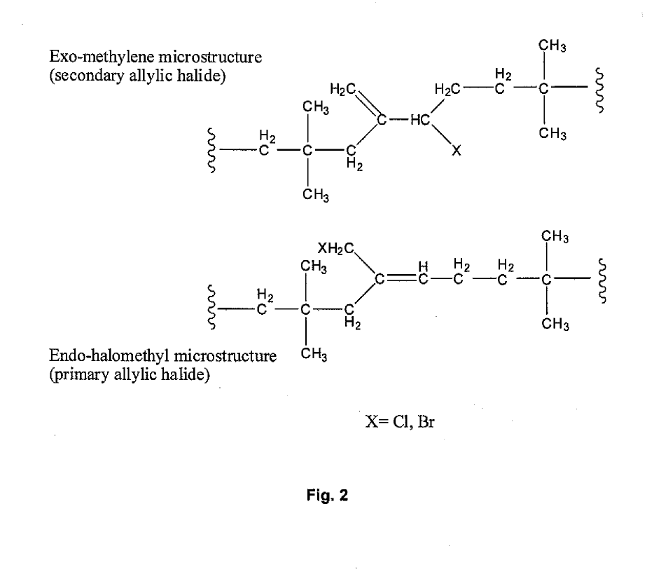

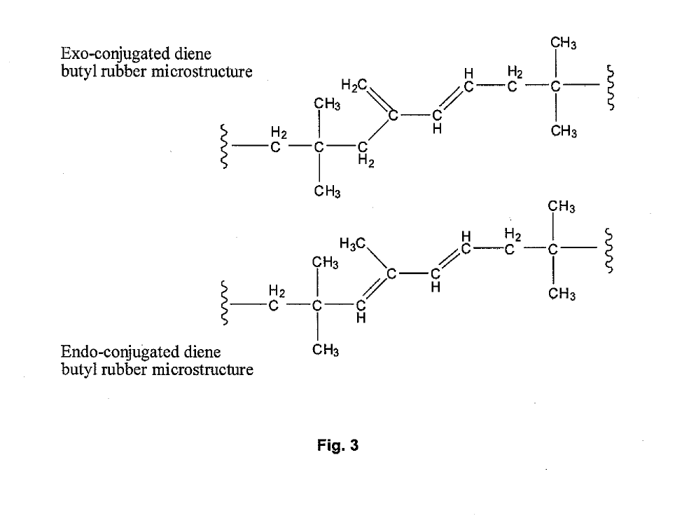

Microstructures of IIR and XIIR have been examined in detail by ¹H NMR spectroscopy (see Chu, C. Y. et al. (1985) Macromolecules 18:1423-1430; Chu, C. Y. et al. (1987) Rubber Chem. Technol. 60: 636-646; Cheng, D. M., et al. (1990) Rubber Chem. Technol. 63:265-275; and White, J. L., et al. (1995) Macromolecules 28:3290-3300). Isoprene units in IIR are incorporated predominantly as 1,4-(E)-isomer with detectable amounts of 1,4-(Z)-isomer (see FIG. 1). Commercially available XIIRs have as their predominant microstructure a secondary allylic halide isomer, which is referred to herein as an exo-methylene isomer (see FIG. 2). A primary allylic halide has also been identified as a minor microstructure and is referred to herein as an endo-halomethyl isomer (see FIG. 2); this microstructure can exhibit two isomeric forms, referred to herein as the (E)- and (Z)-forms. Trace amounts of other microstructures have also been reported, including endo-conjugated diene (see FIG. 3). It has been shown that, at elevated temperatures in organic solvents, rapid rearrangement of the exo-methylene isomer of BIIR to form endo-halomethyl isomer occurs and is accompanied by formation of an exo-conjugated diene butyl rubber (see FIG. 3) through loss of hydrogen bromide (Parent, J. S., Thom, D. J., White, G., Whitney, R. A. and Hopkins, W., J. Polym. Sci. Part A: Polym. Chem., 29, 2019-2026, (2001)). Such rearrangement is advantageous since it provides a halobutyl rubber that is more reactive toward a wide range of nucleophiles, thereby supporting more efficient processes for producing butyl rubber derivatives.

A method is provided for rearranging halogenated butyl rubber from a microstructure that is predominantly exo-methylene (secondary allylic halide) to form a material that is predominantly endo-halomethyl (primary allylic halide). As defined above, the term “isomerized halobutyl rubber” refers to XIIR whose primary allylic halide content exceeds its secondary allylic halide content. Primary allylic halide sites are more reactive than secondary allylic halide sites. By forming isomerized halobutyl rubber, this method provides a halobutyl rubber product that is more reactive relative to regular (i.e., unrearranged) halobutyl rubber toward a wide range of nucleophiles. In this way, the method described herein supports more efficient processes for producing a variety of butyl rubber derivatives.

Such rearrangement could not be accomplished using conventional metal halide technology (e.g., employing Friedel-Crafts catalyst(s)) that use hydrocarbon solution that includes water, because any water interferes with such moisture intolerant catalyst(s). This rearrangement also could not be accomplished using conventional metal halide technology under solvent-free conditions without incurring crosslinking, which is undesirable (at this stage) since it compromises the processing characteristics of the elastomer.

Aspects of the present invention provide a method of catalyzing the rearrangement of conventional grade halobutyl rubber from a microstructure in which the halogen is predominantly in a secondary allylic position to one in which the halogen is predominantly in a primary allylic position. More primary allylic halides means greater reactivity toward a broader range of nucleophiles. As exemplified in the Working Examples and Figures, isomerized BIIR reacts with specified nucleophiles at rates that are orders of magnitude higher than unrearranged BIIR.

Using previously known isomerisation techniques, side-reactions (i.e., dehydrohalogenation) of XIIR led to formation of product that included conjugated diene and HX. These side-reactions are undesirable because allylic halide functionality is consumed that could otherwise participate in curing or functionalization. Advantageously, aspects of this invention provide methods to isomerize XIIR without dehydrohalogenation, and form substantially no conjugated diene and substantially no HX.

Methods of preparing isomerized halobutyl rubber that are described herein comprise contacting halogenated butyl rubber with a metal carboxylate catalyst. In some embodiments, heat is also added.

In regard to the halogenated butyl rubber, in certain embodiments, halogen content of

XIIR is in the range of about 0.5% to about 4.0% by weight (i.e., mass of halogen per mass of total rubber). In certain embodiments, it is about 0.8% to about 3.0% by weight. In some embodiments, it is about 1.0% to about 2.5% by weight.

In regard to the catalyst, in certain embodiments rearrangement is catalyzed by a metal carboxylate salt of an alkali earth metal, wherein the catalyst is a compound of formula (R¹COO)M(OOCR²), where M is a group 2 element of the Periodic Table of the Elements (ie., Be, Mg, Ca, Sr, Ba, or Ra), R¹ and R² are independently C₁-C₂₀ aliphatic, aryl, or a combination thereof, and may optionally be joined, together with the atoms to which they are attached, to form a bi-dentate ligand. In certain embodiments, M is magnesium. A non-limiting example of a catalyst of this formula is magnesium(stearate)₂.

In another embodiment, rearrangement is catalyzed by a metal carboxylate salt of the formula (R¹COO)M(OOCR²), where R¹ and R² are as defined above and M is an element from one of Groups 3 through 13, or Ge, Sn or Pb from Group 14 of the Periodic Table of the Elements. Preferably, M is a non-radioactive element. In some embodiments, M is an element with low to no toxicity. In certain embodiments of catalysts of this formula, M is zinc or iron. Non-limiting examples of catalysts of this formula are zinc(stearate)₂ and iron(napthenate)₂. Examples of such carboxylate salts are shown to be effective catalysts in the Working Examples and Figures. Other compounds that are of this formula that are expected to catalyze the isomerization include boron triacetate and aluminum tristearate.

For clarity, the IUPAC designation of group numbers in the Periodic Table of the

Elements denotes group numbers 1-18 from left to right, one number per column, increasing from 1 at the leftmost column to 18 at the rightmost column. Therefore, elements are designated to groups as follows: Group 3 includes Sc, Y, La. Group 4 includes Ti, Zr, and Hf. Group 5 includes V, Nb, and Ta. Group 6 includes Cr, Mo, and W. Group 7 includes Mn, Tc, and Re. Group 8 includes Fe, Ru, and Os. Group 9 includes Co, Rh, and Ir. Group 10 includes Ni, Pd, and Pt. Group 11 includes Cu, Ag, and Au. Group 12 includes Zn, Cd and Hg. Group 13 includes B, Al, Ga, In, and Tl. Group 14 includes C, Si, Ge, Sn and Pb.

In yet another embodiment, the catalyst is a carboxylate compound of tin, namely (R¹COO)(R²COO)SnR³ R⁴, where R¹, R², R³, and R⁴ are independently C₁-C₂₀ aliphatic, aryl, or a combination thereof, and may optionally be joined, together with the atoms to which they are attached, to form a multi- (i.e., bi-, tri-, or tetra-) dentate ligand. A non-limiting example of a catalyst of this formula is dibutyltin dilaurate.

As one with skill in the art of the invention will recognize, it is possible to utilize a combination of two or more metal carboxylates described herein according to the invention.

In certain aspects of the invention, isomerized halobutyl rubber is prepared in a solution of halobutyl rubber and a suitable solvent (i.e., a solvent in which halobutyl rubber dissolves). Solvent selection is not particularly restricted, and the choice thereof for use in the present process is within the purview of a person skilled in the art. Non-limiting examples of suitable solvents include toluene, hexane, tetrahydrofuran, xylene and mixtures thereof. Typically, halobutyl rubber is dissolved to a concentration of about 0.5 wt % to about 25 wt %. In certain embodiments, it is dissolved to a concentration of about 5 wt % to about 15 wt %. Once the halobutyl rubber is dissolved in the solvent, metal carboxylate salt is added to the solution. In some embodiments, heat is added. In certain embodiments where heat is added, heat is added by heating the resulting mixture. In certain other embodiments, heat is added by heating the polymer solution prior to adding the metal carboxylate catalyst.

Reaction temperature for a solution-borne process can vary from about 20° C. to about 160° C. In some embodiments, reaction temperature is between about 40° C. and about 140° C. In certain embodiments, reaction temperature is between about 60° C. and about 120° C. If the reaction is conducted above the boiling point of the solvent, then pressure can be applied to maintain a liquid-phase condition.

In an embodiment of the invention, isomerized halobutyl rubber is prepared in the absence of solvent. Such reactions are conducted using conventional polymer processing equipment that is known to those skilled in the art, including internal mixers, two-roll mills, extruders, and the like. Typically, halobutyl rubber is mixed with a metal carboxylate. In some embodiments, the mixture is then heated. Reaction temperature for a solvent-free process can vary from about 50° C. to about 160° C. In some embodiments, it is in the range from about 60° C. to about 140° C. In certain embodiments, it is in the range from about 70° C. to about 120° C.

Reaction rate is affected by the amount of catalyst used in the rearrangement process. Higher metal carboxylate concentrations increase the rate of isomerization to form primary allylic halide. The amount of catalyst relative to halogenated butyl rubber can vary from about 0.05 wt % to about 5 wt %. In some embodiments it is from about 0.5 wt % to about 2 wt %.

Exo-conjugated diene butyl rubber has been prepared using copper oxide catalyzed dehydrohalogenation of halobutyl rubbers (see U.S. Pat. No. 4,288,575, Sep. 8, 1981 by Gardner et al.). As described further in Example 6 below, the primary allylic halide (endo-halomethyl isomer) is a thermodynamically more stable isomer with respect to dehydrohalogenation to form conjugated-diene butyl rubber. Since the copper oxide catalyst is intended for the purpose of dehydrohalogenation, rearrangement of exo-allylic halide to endo-allylic halide is accompanied by dehydrohalogenation and the examples provided are carried out as solution processes in hydrocarbon solvents. U.S. Pat. No. 4,632,963 (Dec. 30, 1986), U.S. Pat. No. 4,634,741 (Jan. 6, 1987), U.S. Pat. No. 4,649,178 (Mar. 10, 1978), U.S. Pat. No. 4,681,921 (Jul. 21, 1987) and U.S. Pat. No. 4,703,091 (Oct. 27, 1987) by Gardiner et al. further disclose the use of Freidel-Crafts catalysts (ZnCl₂ or FeCl₃) and strong Bronsted adds (hydrogen bromide or hydrogen chloride) as catalysts for the preparation of halogenated butyl rubbers with high mole ratios of endo-halomethyl (primary allylic halide) isomers from commercial grades of halobutyl rubbers containing very low amounts of endo-halomethyl (primary allylic halide) isomers as solution processes in hydrocarbon solvents. As described above, in contrast to the Gardiner et al. techniques, the present invention advantageously provides a method of catalyzing the isomerization to form endo-halomethyl (primary allylic halide) isomers and does not form conjugated diene. Also in contrast to the Gardiner et al. techniques, the present invention can be conducted in the absence of solvent.

Referring to FIG. 1, a structure diagram is presented that displays predominant microstructures of butyl rubber.

Referring to FIG. 2, a structure diagram is presented that displays predominant microstructures of halogenated butyl rubber.

Referring to FIG. 3, a structure diagram is presented that displays predominant microstructures of conjugated-diene butyl rubber.

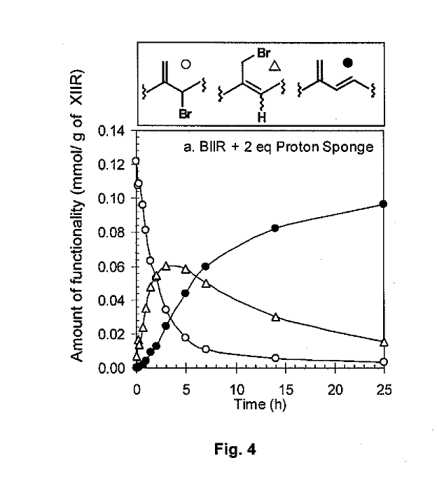

Referring to FIG. 4, a plot is shown that presents solution dynamics for dehydrohalogenation of BIIR to conjugated-diene butyl rubber in xylenes solution at reflux (135° C.) in the presence of Proton-sponge®. This plot of concentration of functionality (mmol functionality/g of XIIR) versus time (h) for secondary allylic bromide exo-methylene bromobutyl rubber, primary allylic bromide (E/Z)-endo-bromomethyl butyl rubber, and exo-conjugated diene butyl rubber indicates that the amount of endo-conjugated butyl rubber is unchanged during the reaction.

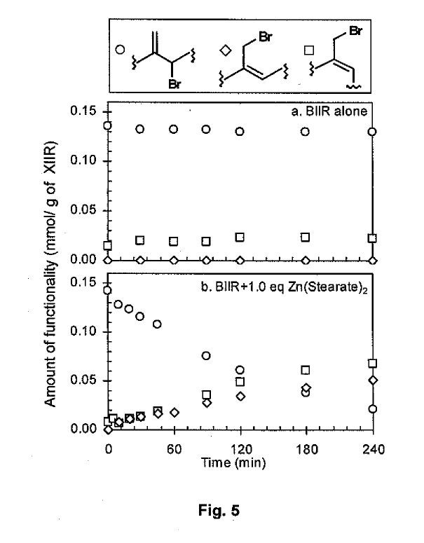

Referring to FIG. 5, a plot is shown that graphically compares solution dynamics for rearrangement of BIIR in toluene at 85° C. both alone (upper plot a.) and in the presence of 1 molar equivalent of zinc stearate (lower plot b.) from exo-methylene microstructure (secondary allylic bromide) to (Z)-endo-bromomethyl butyl rubber (primary allylic bromide) and (E)-endo-bromomethyl butyl rubber (primary allylic bromide). Notably, the amount of endo-conjugated butyl rubber is unchanged during the reaction for the upper plot, where there is no metal carboxylate salt present.

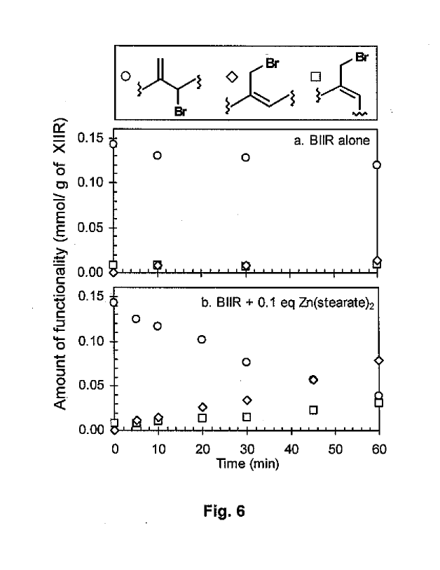

Referring to FIG. 6, a plot is shown that graphically compares solid-state dynamics for rearrangement of BIIR at 85° C. in a batch mixer both alone (upper plot a.) and in the presence of 0.1 molar equivalent of zinc stearate (lower plot b.) from exo-methylene microstructure (secondary allylic bromide) to (Z)-endo-bromomethyl butyl rubber (primary allylic bromide) and (E)-endo-bromomethyl butyl rubber (primary allylic bromide).the amount of endo-conjugated butyl rubber is unchanged during the reaction.

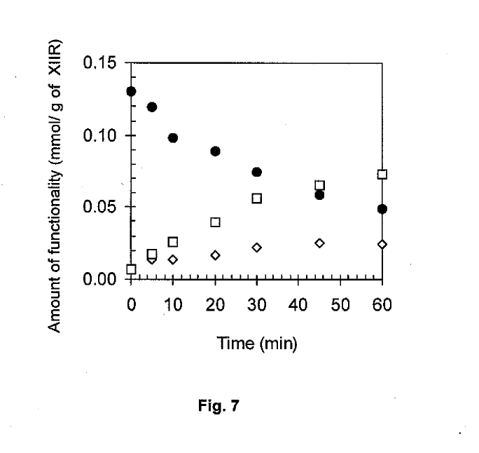

Referring to FIG. 7, a plot is shown that graphically shows solid-state dynamics for rearrangement of BIIR at 85° C. in a batch mixer in the presence of 0.1 molar equivalent of iron naphthenate from exo-methylene microstructure (secondary allylic bromide) to (Z)-endo-bromomethyl butyl rubber (primary allylic bromide) and (E)-endo-bromomethyl butyl rubber (primary allylic bromide). Notably, the amount of endo-conjugated butyl rubber is unchanged during the reaction.

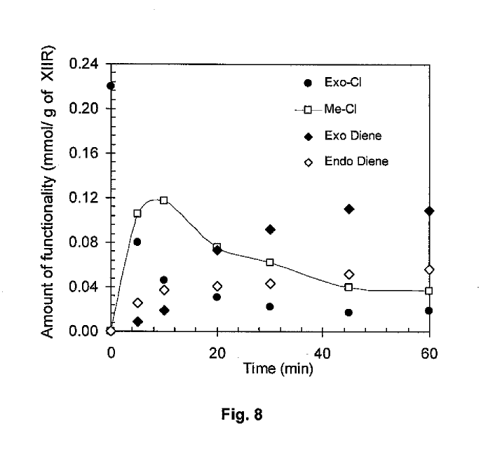

Referring to FIG. 8, a plot is shown that graphically presents solid-state dynamics for rearrangement of CIIR at 120° C. in a batch mixer in the presence of 0.1 molar equivalent of zinc stearate from exo-methylene chlorobutyl rubber (secondary allylic chloride) to endo-chloromethyl butyl rubber (primary allylic chloride) microstructure, exo conjugated-diene butyl rubber, and endo conjugated-diene butyl rubber.

The following examples further illustrate the present invention and are not intended to be limiting in any respect.

### WORKING EXAMPLES

### Materials and Methods

Bromobutyl rubber (LANXESS BB2030, allylic bromide content about 0.15 mmol per gm) and chlorobutyl rubber (LANXESS CB1240, allylic chloride content about 0.22 mmol per gm) were used as supplied by LANXESS Inc. (Sarnia, Ontario, Canada). The following reagents were used as received: 1,8-bis(dimethylamino)-naphthalene (Proton-sponge® 99%, Sigma-Aldrich, Oakville, Ontario, Canada); zinc stearate (90%, Fisher Scientific, Ottawa, Ontario, Canada); iron naphthenate (80% in mineral spirits, Alfa Aesar, Ward Hill, Mass., USA).

¹H NMR spectra were acquired in CDCl₃ on a Bruker Avance-600 spectrometer (available from Bruker, Milton, Ontario, Canada) with chemical shifts referenced to tetramethylsilane. Solid-state reactions were done using a Haake Polylab R600 internal batch mixer (Thermo Scientific, Waltham, Mass., USA).

### Example 1

### Solution Dehydrohalogenation of Bromobutyl Rubber (for Comparison)

Bromobutyl rubber (17.5 g, 2.26 mmol allylic bromide, 90:10 ratio of secondary allylic bromide to primary allylic bromide) and 1,8-bis(dimethylamino)naphthalene (1.46 g, 6.82 mmol) were dissolved in xylenes (350 mL), then heated to reflux with stirring. Polymer samples withdrawn at intervals were isolated by precipitation from acetone and dried under vacuum. Downfield ¹H NMR (CDCl₃) analysis: for exo-conjugated diene butyl rubber, 6 4.76 (s, 1H, HCH═), 5.04 (s, 1H, HCH═), 5.73 (m, 1H, —CH₂—CH═), 6.05 (d, 1H, —CH═C(CH₃)—CH═); for endo-conjugated diene butyl rubber, δ 5.40 (bs, 1H, —CH═C(CH₃)—), 5.50 (m, 1H, CH₂—CH═), 5.93 (1H, ═C(CH₃)—CH═); for allylic bromides: δ 5.39 (secondary allylic bromide, ═CHH, 1 H, s), 5.01 (secondary allylic bromide, ═CHH, 1H, s), 4.40 (secondary allylic bromide, —CHBr—, 1H, m); δ 5.41 ((E)-primary allylic bromide, HC═, 1H, t), 4.11 ((E)-primary allylic bromide, ═C—CH₂—Br, 2H, s), δ 5.75 ((Z)-primary allylic bromide, HC═, 1H, t), 4.09 ((Z)-primary allylic bromide, ═C—CH₂—Br, 2H, s). After 25 hr, the ratio of secondary allylic bromide: primary allylic bromide: exo-conjugated-diene butyl rubber was 5:15:80.

The dynamics of dehydrohalogenation shown in FIG. 4 indicate that loss of hydrogen bromide to form conjugated diene butyl rubber is a slow thermal process taking extended reaction times (25 hrs) as a solution process in the absence of a catalyst but the presence of a non-nucleophilic base (Proton-sponge). This solution process is accompanied by an increase in the ratio of primary allylic bromide to secondary allylic bromide.

### Example 2

### Solution Rearrangement of Bromobutyl Rubber in the Presence of a Metal Carboxylate Catalyst (Zinc Stearate)

Bromobutyl rubber (1 g) and the catalyst (0.12 g zinc stearate) were dissolved in toluene (22 mL) in a flask, then heated with stirring in an oil bath at 85° C. Polymer samples withdrawn at intervals were isolated by precipitation from acetone and dried under vacuum. Downfield ¹H NMR (CDCl₃) analysis: for exo-conjugated diene butyl rubber, 6 4.76 (s, 1 H, HCH═), 5.04 (s, 1H, HCH═), 5.73 (m, 1H, —CH₂—CH═), 6.05 (d, 1H, —CH═C(CH3)—CH═); for endo-conjugated diene butyl rubber, δ 5.40 (bs, 1H, —CH═C(CH₃)—), 5.50 (m, 1H, CH₂—CH═), 5.93 (1H, ═C(CH₃)—CH═); for allylic bromides: δ 5.39 (secondary allylic bromide, ═CHH, 1H, s), 5.01 (secondary allylic bromide, ═CHH, 1H, s), 4.40 (secondary allylic bromide, —CHBr—, 1H, m); δ 5.41 ((E)-primary allylic bromide, HC═, 1H, t), 4.11 ((E)-primary allylic bromide, ═C—CH₂—Br, 2H, s), δ 5.75 ((Z)-primary allylic bromide, HC═, 1H, t), 4.09 ((Z)-primary allylic bromide, ═C—CH₂—Br, 2H, s). After 6 hr, the ratio of secondary allylic bromide: primary allylic bromide: exo-conjugated-diene butyl rubber was 15:85:0. No gel formation was observed.

The dynamics of rearrangement shown in FIG. 5 indicate that the presence of a metal carboxylate catalyst in solution leads to substantial rearrangement of the secondary allylic bromide to primary allylic bromide without significant amounts of exo-conjugated diene butyl rubber being formed. The rearrangement takes place in a shorter period of time and at a lower temperature in the presence of zinc stearate as a catalyst.

### Example 3

### Solid-State Rearrangement of Bromobutyl Rubber with a Metal Carboxylate Catalyst (Zinc Stearate)

Bromobutyl rubber (40 g) was charged to a Haake Rheomix 600 batch-mixing bowl equipped with Banbury blades rotating at 60 rpm at a set-point temperature of 85° C. After 2 minutes, the catalyst was added (0.1 eq, 0.69 g zinc stearate). Samples withdrawn at regular intervals were characterized by downfield ¹H NMR (CDCl₃) analysis: for exo-conjugated diene butyl rubber, δ 4.76 (s, 1H, HCH═), 5.04 (s, 1H, HCH═), 5.73 (m, 1H, —CH₂—CH═), 6.05 (d, 1H, —CH═C(CH₃)—CH═); for endo-conjugated diene butyl rubber, δ 5.40 (bs, 1H, —CH═C(CH₃)—), 5.50 (m, 1H, CH₂—CH═), 5.93 (1H, ═C(CH₃)—CH═); for allylic bromides: δ 5.39 (secondary allylic bromide, ═CHH, 1H, s), 5.01 (secondary allylic bromide, ═CHH, 1H, s), 4.40 (secondary allylic bromide, —CHBr—, 1H, m); δ 5.41 ((E)-primary allylic bromide, HC═, 1H, t), 4.11 ((E)-primary allylic bromide, ═C—CH₂—Br, 2H, s), δ 5.75 ((Z)-primary allylic bromide, HC═, 1H, t), 4.09 ((Z)-primary allylic bromide, ═C—CH₂—Br, 2H, s). After 1 hr, the ratio of secondary allylic bromide: primary allylic bromide: exo-conjugated-diene butyl rubber was 20:80:0. No gel formation was observed.

The dynamics of rearrangement shown in FIG. 6 indicate that the presence of a catalyst (zinc stearate), but the absence of solvent, leads to substantial rearrangement of the secondary allylic bromide to primary allylic bromide without significant amounts of exo-conjugated diene butyl rubber being formed. The rearrangement takes place in a shorter period of time than the solvent based rearrangement.

### Example 4

### Solid-State Rearrangement of Bromobutyl Rubber with a Catalyst (Iron Naphthenate)

Bromobutyl rubber (40 g) was charged to a Haake Rheomix 600 batch-mixing bowl equipped with Banbury blades rotating at 60 rpm at a set-point temperature of 85° C. After 2 minutes, the catalyst was added (0.1 eq, 0.49 g iron naphthenate in mineral spirits). Samples withdrawn at regular intervals were characterized by downfield ¹H NMR (CDCl₃) analysis: for exo-conjugated diene butyl rubber, δ 4.76 (s, 1H, HCH═), 5.04 (s, 1H, HCH═), 5.73 (m, 1H, —CH₂—CH═), 6.05 (d, 1H, —CH═C(CH₃)—CH═); for endo-conjugated diene butyl rubber, δ 5.40 (bs, 1H, —CH═C(CH₃)—), 5.50 (m, 1H, CH₂—CH═), 5.93 (1H, ═C(CH₃)—CH═); for allylic bromides: δ 5.39 (secondary allylic bromide, ═CHH, 1H, s), 5.01 (secondary allylic bromide, ═CHH, 1H, s), 4.40 (secondary allylic bromide, —CHBr—, 1H, m); δ 5.41 ((E)-primary allylic bromide, HC═, 1H, t), 4.11 ((p-primary allylic bromide, ═C—CH₂—Br, 2H, s), δ 5.75 ((Z)-primary allylic bromide, HC═, 1H, t), 4.09 ((Z)-primary allylic bromide, ═C—CH₂—Br, 2H, 5). After 1 hr, the ratio of secondary allylic bromide: primary allylic bromide: exo-conjugated-diene butyl rubber was 30:70:0. No gel formation was observed.

The dynamics of rearrangement shown in FIG. 7 indicate that the presence of a catalyst (iron naphthenate), but the absence of solvent, leads to substantial rearrangement of the secondary allylic bromide to primary allylic bromide without significant amounts of exo-conjugated diene butyl rubber being formed. The rearrangement takes place in a shorter period of time than the solvent based rearrangement.

### Example 5

### Solid-State Rearrangement of Chlorobutyl Rubber with a Catalyst (Zinc Stearate)

Chlorobutyl rubber (40 g) was charged to a Haake Rheomix 600 batch-mixing bowl equipped with Banbury blades rotating at 60 rpm at a set-point temperature of 120° C. After 2 minutes, the catalyst was added (0.1 eq, 0.69 g zinc stearate). Samples withdrawn at regular intervals were characterized by downfield ¹H NMR (CDCl₃) analysis: for exo-conjugated diene butyl rubber, δ 4.76 (s, 1H, HCH═), 5.04 (s, 1H, HCH═), 5.73 (m, 1H, —CH₂—CH═), 6.05 (d, 1H, —CH═C(CH₃)—CH═); for endo-conjugated diene butyl rubber, δ 5.40 (bs, 1H, —CH═C(CH₃)—), 5.50 (m, 1H, CH₂—CH═), 5.93 (1H, ═C(CH₃)—CH═); for allylic chlorides: δ 5.35 (secondary allylic chloride, ═CHH, 1H, s), 5.01 (secondary allylic chloride, ═CHH, 1H, s), 4.20 (secondary allylic chloride, —CHCl—, 1H, m); 6 4.11 ((E/Z)-primary allylic chloride, ═C—CH₂—Cl, 2H, s). After 10 min, the ratio of secondary allylic chloride: primary allylic chloride: exo-conjugated-diene butyl rubber was 20:55:25. No gel formation was observed.

It will be understood by those skilled in the art that this description is made with reference to certain preferred embodiments and that it is possible to make other embodiments employing the principles of the invention which fall within its spirit and scope as defined by the claims.

1. A process for isomerizing halogenated butyl rubber comprising:
mixing halogenated butyl rubber and a catalytic amount of metal carboxylate; and
forming isomerized halogenated butyl rubber.

2. The process of claim 1, further comprising heating the halogenated butyl rubber and metal carboxylate mixture.

3. The process according to claim 1, wherein the halogenated butyl rubber is brominated butyl rubber or chlorinated butyl rubber.

4. The process of claim 1, wherein the metal carboxylate is magnesium(stearate)₂, zinc(stearate)₂, iron(naphthenate)₂, dibutyltin dilaurate, or a combination thereof.

5. The process of claim 1, wherein the mixing is conducted in the absence of solvent.

6. The process of claim 5, wherein the mixing is conducted at a temperature from about 50° C. to about 160° C.

7. The process of claim 5, wherein the mixing is conducted at a temperature from about 60° C. to about 140° C.

8. The process of claim 5, wherein the mixing is conducted at a temperature from about 70° C. to about 120° C.

9. The process of claim 1, wherein the mixing is conducted in the presence of solvent.

10. The process of claim 9, wherein the solvent is toluene, hexane, tetrahydrofuran, xylene, or a combination thereof.

11. The process of claim 9, wherein halobutyl rubber is dissolved to a concentration from about 0.5 wt % to about 25 wt %.

12. The process of claim 9, wherein halobutyl rubber is dissolved to a concentration from about 5 wt % to about 15 wt %.

13. The process of claim 1, wherein the mixing is conducted at a temperature from about 20° C. to about 160° C.

14. The process of claim 13, wherein the mixing is conducted at a temperature from about 40° C. to about 140° C.

15. The process of claim 13, wherein the mixing is conducted at a temperature from about 60° C. to about 120° C.

16. The process of any one of claim 9, wherein the mixing is conducted above the solvent's boiling point, further comprising applying pressure to maintain a liquid phase.

17. The process of claim 1, wherein the metal carboxylate is (R¹COO)M(OOCR²), where M is Be, Mg, Ca, Sr, Ba, or Ra, and R¹ and R² are independently C₁-C₂₀ aliphatic, aryl, or a combination thereof, and optionally may be joined together as a bi-dentate ligand.

18. The process of claim 17 wherein the metal carboxylate is magnesium(stearate)₂ .

19. The process of claim 1, wherein the metal carboxylate is (R¹COO)M(OOCR²), where M is an element from one of Groups 3 through 13 or Ge, Sn or Pb of Group 14 of the Periodic Table of the Elements, R¹ and R² are independently C₁-C₂₀ aliphatic, aryl, or a combination thereof, and optionally may be joined together as a bi-dentate ligand.

20. The process of claim 19, wherein the metal is zinc or iron.

21. The process of claim 20, wherein the metal carboxylate is zinc(stearate)₂ or iron(naphthenate)₂.

22. The process of claim 1, wherein the metal carboxylate is (R¹COO)(R²COO)SnR³R⁴, where R¹, R², R³, and R⁴ are independently C₁-C₂₀ aliphatic, aryl, or a combination thereof, and optionally two or more of R¹, R², R³, and R⁴ can join together as a multi-dentate ligand.

23. The process of claim 22, wherein the metal carboxylate is dibutyltin dilaurate.
